(19) United States
(12) Patent Application Publication
(10) Pub. No.: US 2023/0178715 A1
(43) Pub. Date: Jun. 8, 2023

(54) LITHIUM SECONDARY BATTERY WITH HIGH DURABILITY AND MANUFACTURING METHOD THEREOF

(71) Applicants: Hyundai Motor Company, Seoul (KR); Kia Corporation, Seoul (KR)

(72) Inventors: Young Jin Nam, Suwon (KR); Hong Suk Choi, Hwaseong (KR); Sang Wan Kim, Daejeon (KR); Seon Hwa Kim, Cheongju (KR); Hee Soo Kang, Seoul (KR); Jae Min Lim, Suwon (KR); Sung Man Cho, Gwacheon (KR)

(21) Appl. No.: 17/985,870

(22) Filed: Nov. 13, 2022

(30) Foreign Application Priority Data
Dec. 6, 2021 (KR) 10-2021-0172511

(51) Int. Cl. H01M 4/36; H01M 4/134; H01M 4/62; H01M 4/133; H01M 10/0525

(52) U.S. Cl. CPC H01M 4/366; H01M 4/134; H01M 4/624; H01M 4/133; H01M 10/0525; H01M 2004/027

(57) ABSTRACT

Provided are a lithium secondary battery having high durability and a method for manufacturing the same. The lithium secondary battery includes a reinforcing layer positioned on the outside of at least one of a negative electrode current collector and a positive electrode current collector and including a matrix containing a polymer and a thermally conductive filler dispersed in the matrix.

### CROSS-REFERENCE TO RELATED APPLICATION

This application claims under 35 U.S.C. § 119(a) the benefit of priority to Korean Patent Application No. 10-2021-0172511 filed on Dec. 6, 2021, the entire contents of which are incorporated herein by reference.

### TECHNICAL FIELD

The present disclosure relates to a lithium secondary battery having high durability and a method for manufacturing the same.

### BACKGROUND

A lithium secondary battery is a secondary battery having the highest energy density among currently commercialized secondary batteries, and may be used in various fields such as electric vehicles.

Commercially available negative electrode active materials for lithium secondary batteries include graphite. Graphite has a structure in which a single layer of carbon atoms that are bonded together is stacked in multiple layers. When the lithium secondary battery is charged, lithium ions move from the positive electrode to the negative electrode and enter between the layers of graphite, and the graphite expands. Meanwhile, graphite has a theoretical capacity of 372 mAh/g, but is limited in its application to electric vehicles and large-capacity energy storage systems that require high energy density. Thus, interest in a silicon-based material as a negative electrode active material that can replace graphite has increased. The silicon-based material has an energy density about 10 times greater than that of graphite and also has higher charge/discharge rates. However, the degree of expansion of the silicon-based material during charging is excessively higher than that of graphite. When lithium ions enter, graphite expands about 10%, but the silicon-based material expands about 400%.

Meanwhile, there has been an attempt to use lithium metal as a negative electrode material in order to further increase the energy density of the lithium secondary battery. Lithium metal has attracted attention as a negative electrode material that can realize high energy density, due to its advantages, including a high theoretical capacity of 3,860 mAh/g and a very low redox potential (−3.04 V vs. S.H.E).

However, in a lithium secondary battery including lithium metal as a negative electrode material, lithium ions are deposited on the lithium metal during charging, and in this process, local volume expansion occurs due to non-uniform deposition of lithium.

Another development direction for lithium secondary batteries includes an all-solid-state battery that employs a solid electrolyte instead of a liquid electrolyte. The all-solid-state battery is a three-layer laminate including: a positive electrode layer bonded to a positive electrode current collector; a negative electrode layer joined to a negative electrode current collector; and a solid electrolyte layer interposed between the positive electrode layer and the negative electrode layer.

The negative electrode layer of the all-solid-state battery is formed by mixing a negative electrode active material and a solid electrolyte for ensuring ionic conductivity. Since the solid electrolyte has a greater specific gravity than a liquid electrolyte, the conventional all-solid-state battery described above has a lower energy density than the lithium ion battery.

Accordingly, in order to increase the energy density of the all-solid-state battery, studies on the application of lithium metal as a negative electrode material have been conducted. However, problems such as the above-described non-uniform deposition of lithium, interfacial bonding, the growth of dendrites, high prices, and difficulty in increasing a large-area all-solid-state battery could not be solved.

In recent years, there have been conducted studies on a storage type, anodeless type all-solid-state battery which is free of a negative electrode and in which lithium is deposited directly on the negative electrode current collector. However, the above-described anodeless type all-solid-state battery also has a problem in that the lifespan and durability of the battery are very poor due to local volume expansion caused by non-uniform deposition of lithium, increased irreversible reactions, and the like.

### SUMMARY

In preferred aspects, provided a lithium secondary battery capable of preventing breakage of a current collector from occurring due to volume expansion of an electrode.

Objects of the present disclosure are not limited to the above-mentioned object. Objects of the present disclosure will become more apparent from the following description, and will be realized by means described in the claims and combinations thereof.

In an aspect, provided is a lithium secondary battery that may include: a negative electrode current collector; a negative electrode layer disposed on the negative electrode current collector; an intermediate layer disposed on the negative electrode layer and including a solid electrolyte or a separator; a positive electrode layer disposed on the intermediate layer; a positive electrode current collector disposed on the positive electrode layer; and a reinforcing layer disposed on the outside of at least one of the negative electrode current collector and the positive electrode current collector and including a matrix including a polymer and a thermally conductive filler dispersed in the matrix.

The negative electrode layer may include a negative electrode active material or lithium metal.

The negative electrode layer may include amorphous carbon and one or more metal selected from the group consisting of gold (Au), platinum (Pt), palladium (Pd), silicon (Si), silver (Ag), aluminum (Al), bismuth (Bi), tin (Sn), and zinc (Zn). The metal may be alloyable with lithium or form alloy with lithium.

The polymer may comprise a copolymer including one or more selected from the group consisting of amide, chlorobutadiene, butadiene, isoprene, epoxy, vinyl chloride, biphenyl chloride, terephthalic acid, lactic acid, vinyl alcohol, styrene, ethylene, propylene, ester, acrylonitrile, acrylic acid, alginic acid, vinylidene difluoride, cellulose, and bisphenol A.

The thermally conductive filler may be in the form of particles, and may have an average particle diameter of about 50 nm to 500 nm.

The thermally conductive filler may include one or more inorganic filler selected from the group consisting of boron nitride (BN), aluminum nitride (AlN), and silicon carbide (SiC).

The thermally conductive filler may include one or more selected from the group consisting of graphite, carbon nanotubes (CNTs), and graphene.

The reinforcing layer may include the thermally conductive filler in an amount of about 1 to 400 parts by weight based on 100 parts by weight of the polymer.

The thickness of the reinforcing layer may be about 1% to 100% of the thickness of a current collector adjacent to the reinforcing layer.

The thickness of the reinforcing layer may be about 0.1 μm to 10 μm.

In an aspect, provided is a method for manufacturing a lithium secondary battery that may include steps of: preparing a coating solution containing a polymer and a thermally conductive filler; forming a reinforcing layer by applying the coating solution to at least one surface of a negative electrode current collector and a positive electrode current collector; and forming a laminate including: a negative electrode current collector; a negative electrode layer disposed on the negative electrode current collector; an intermediate layer disposed on the negative electrode layer and including a solid electrolyte or a separator; a positive electrode layer disposed on the intermediate layer; a positive electrode current collector disposed on the positive electrode layer; and a reinforcing layer disposed on the outside of at least one of the negative electrode current collector and the positive electrode current collector.

The coating solution may be prepared by adding the polymer to a solvent at a concentration of about 1 wt % to 10 wt % to obtain a polymer solution and adding the thermally conductive filler to the polymer solution in an amount of about 1 to 400 parts by weight based on 100 parts by weight of the polymer.

The solvent may include one or more selected from the group consisting of hexyl butyrate, xylene, butyl butyrate, N-methyl-2-pyrrolidinone, tetrahydrofuran, acrylonitrile, water, and ethanol.

The reinforcing layer may be formed by applying the coating solution to at least one surface of at least one of the negative electrode current collector and the positive electrode current collector by spin coating, inkjet coating, screen printing, or gravure roll coating.

Also provided is a vehicle including the lithium secondary battery as described herein.

Other aspects of the disclosure are described infra.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 shows an exemplary lithium secondary battery according to an exemplary embodiment of the present disclosure;

FIG. 2 shows a state in which an exemplary all-solid-state battery according to an exemplary embodiment of the present disclosure is charged;

FIG. 3 shows an exemplary reinforcing layer according to an exemplary embodiment of the present disclosure;

FIG. 4A shows a computed tomography (CT) image of an all-solid-state battery according to an Example after the all-solid-state battery was charged and discharged 100 times;

FIG. 4B shows a computed tomography (CT) image of an all-solid-state battery according to a Comparative Example after the all-solid-state battery was charged and discharged 100 times;

FIG. 5A shows the results of measuring the capacity retention rates of all-solid-state batteries according to an Example and a Comparative Example; and

FIG. 5B shows the results of measuring the coulombic efficiencies of all-solid-state batteries according to an Example and a Comparative Example.

### DETAILED DESCRIPTION

The above objects, other objects, features and advantages of the present disclosure will become apparent with reference to the embodiments described below in conjunction with the accompanying drawings. However, the present disclosure is not limited to the embodiments disclosed below and may be embodied in a variety of different forms. Rather, these embodiments disclosed herein are provided so that this disclosure will be thorough and complete, and will fully convey the spirit of the present disclosure to those skilled in the art.

Throughout the specification and the accompanying drawings, like reference numerals refer to like components. In the accompanying drawings, the dimensions of structures are exaggerated for clarity of illustration. Although terms such as “first” and “second” may be used to describe various components, the components should not be limited by these terms. These terms are used only to distinguish one component from another component. For example, a first component may be termed a second component without departing from the scope of the present disclosure, and similarly, a second component may also be termed a first component. Singular expressions include plural expressions unless the context clearly indicates otherwise.

In the present specification, it should be understood that terms such as “include” and “have” are intended to denote the existence of mentioned characteristics, numbers, steps, operations, components, parts, or combinations thereof, but do not exclude the probability of existence or addition of one or more other characteristics, numbers, steps, operations, components, parts, or combinations thereof In addition, when a part, such as a layer, film, region, plate, or the like, is referred to as being “on” or “above” another part, it not only refers to a case where the part is directly above the other part, but also a case where a third part exists therebetween. Conversely, when a part, such as a layer, film, region, plate, or the like, is referred to as being “below” another part, it not only refers to a case where the part is directly below the other part, but also a case where a third part exists therebetween.

Since all numbers, values and/or expressions referring to quantities of components, reaction conditions, polymer compositions, and mixtures used in the present specification are subject to various uncertainties of measurement encountered in obtaining such values, unless otherwise indicated, all are to be understood as modified in all instances by the term “about.”

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Where a numerical range is disclosed herein, such a range is continuous, inclusive of both the minimum and maximum values of the range as well as every value between such minimum and maximum values, unless otherwise indicated. Still further, where such a range refers to integers, every integer between the minimum and maximum values of such a range is included, unless otherwise indicated. In the present specification, when a range is described for a variable, it will be understood that the variable includes all values including the end points described within the stated range.

For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

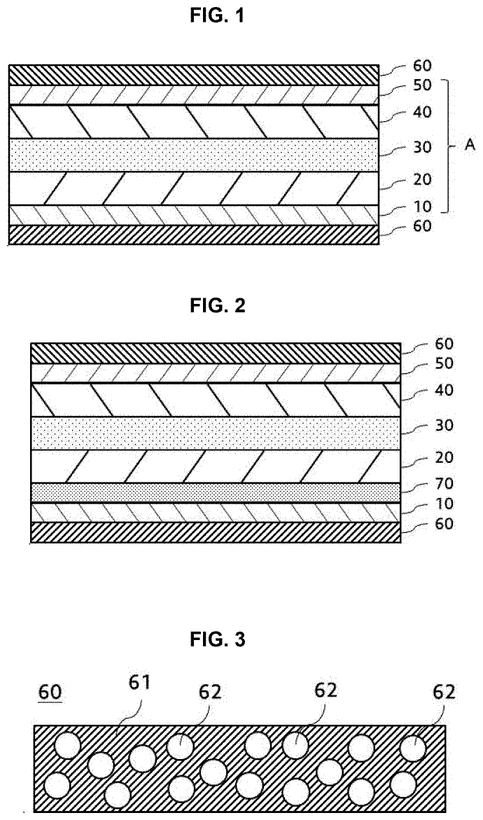

FIG. 1 shows an exemplary lithium secondary battery according to an exemplary embodiment of the present disclosure. The lithium secondary battery may be a laminate A including: a negative electrode current collector 10; a negative electrode layer 20 positioned on the negative electrode current collector 10; an intermediate layer 30 positioned on the negative electrode layer 20; a positive electrode layer 40 positioned on the intermediate layer 30; and a positive electrode current collector 50 positioned on the positive electrode layer 40.

The lithium secondary battery may include the reinforcing layer 60 provided on at least one surface which is the outermost surface in the stacking direction of the layers in the laminate A.

The laminate A may be either a lithium ion battery including a liquid electrolyte, or an all-solid-state battery including a solid electrolyte. Hereinafter, each embodiment will be described in detail.

### Lithium Ion Battery Including a Liquid Electrolyte

Provided herein is a lithium ion battery including a liquid electrolyte.

The negative electrode current collector 10 may be an electrically conductive plate-shaped substrate. The negative electrode current collector 10 may include one or more selected from the group consisting of nickel (Ni), and stainless steel (SUS).

The negative electrode current collector 10 may be a high-density metal thin film having a porosity of less than about 1%.

The negative electrode current collector 10 may have a thickness of about 0.1 μm to 10 μm.

The negative electrode layer 20 may include a negative electrode active material. The negative electrode active material may include a carbon-based material or a silicon-based material.

The carbon-based material may include crystalline carbon, amorphous carbon, or a combination thereof. Examples of the crystalline carbon include graphite such as amorphous, plate-like, flake, spherical or fibrous natural graphite or artificial graphite, and examples of the amorphous carbon include soft carbon (low-temperature calcined carbon), hard carbon, mesophase pitch carbides, and calcined coke.

Examples of the silicon-based material include Si, SiOₓ (0<x<2), a Si-Q alloy (wherein Q is an element selected from the group consisting of an alkali metal, an alkaline earth metal, a group 13 element, a group 14 element, a transition metal, a rare earth element, and combinations thereof, and is not Si), Sn, SnO₂, Sn—R (wherein R is an element selected from the group consisting of an alkali metal, an alkaline earth metal, a group 13 element, a group 14 element, a transition metal, a rare earth element, and combinations thereof, and is not Sn). In addition, a mixture of at least one of these examples and SiO₂ may also be used. As the elements Q and R, those selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof may be used. In addition, a mixture of at least one of the above listed elements and SiO₂ may also be used.

The negative electrode active material may reversibly absorb and releases lithium ions. When the lithium ion battery is charged, lithium ions that have moved from the positive electrode are absorbed into the negative electrode active material, and thus the negative electrode active material expands, which leads to volume expansion of the negative electrode layer 20. Since the negative electrode current collector 10 in contact with the negative electrode layer 20 is made of an electrically conductive metal material as described above, it has poor stress and strain properties, and thus may be broken by volume expansion of the negative electrode layer 20.

Therefore, the present disclosure is characterized in that breakage of the negative electrode current collector 10 is suppressed by applying the reinforcing layer 60 onto the negative electrode current collector 10.

Meanwhile, the negative electrode layer 20 may include lithium metal or a lithium metal alloy.

The lithium metal alloy may include an alloy of lithium and a metal or metalloid alloyable with lithium.

Examples of the metal or metalloid alloyable with lithium include Si, Sn, Al, Ge, Pb, Bi, Sb, and the like.

Lithium metal has a large electric capacity per unit weight, which is advantageous for realization of high-capacity batteries. However, lithium metal may cause a short circuit between the positive electrode layer 40 and the negative electrode layer 20 due to growth of the dendritic structure during the deposition and dissolution of lithium ions. In addition, lithium metal has a high reactivity with an electrolyte, and thus the life of the battery may be reduced due to a side reaction therebetween. Meanwhile, lithium metal undergoes a large volume change during the charging and discharging processes, and thus stress may be applied to the negative electrode current collector 10 attached to the negative electrode layer 20, resulting in breakage of the negative electrode current collector 10. Therefore, the present disclosure is characterized in that breakage of the negative electrode current collector 10 is suppressed by applying the reinforcing layer 60 onto the negative electrode current collector 10. This will be described later.

The intermediate layer 30 may include a separator and an electrolyte impregnated in the separator.

The separator is an ion conductive barrier that allows lithium ions to pass therethrough while blocking electrical contact between the negative electrode layer 20 and the positive electrode layer 40. The separator may include a porous polymer substrate having a plurality of micropores. Example of the polymer substrate include polyolefin, polyethylene terephthalate, polybutylene terephthalate, polyacetal, polyamide, polycarbonate, polyimide, polyether ether ketone, polyether sulfone, polyphenylene oxide, polyphenylene sulfide, polyethylene naphthalene, and the like.

The electrolyte may include an organic solvent and a lithium salt. Examples of the organic solvent include ethylene carbonate, dimethyl carbonate, diethyl carbonate, ethylmethyl carbonate, fluoroethylene carbonate, 1,2-dimethoxyethane, 1,2-diethoxyethane, dimethylene glycol dimethyl ether, trimethylene glycol dimethyl ether, triethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, 1,1,2,2-tetrafluoroethyl 2,2,3,3-tetrafluoropropyl ether, dimethylacetamide, and the like.

The lithium salt may include LiNO₃, LiPF₆, LiBF₆, LiClO₄, LiCF₃SO₃, LiBr, LiI, or the like.

The positive electrode layer 40 may include a positive electrode active material, a binder, a conductive material, and the like.

The positive electrode active material may include at least one selected from the group consisting of lithium cobalt oxide, lithium nickel cobalt manganese oxide, lithium nickel cobalt aluminum oxide, lithium iron phosphate oxide, lithium manganese oxide, and combinations thereof However, the positive active material is not limited thereto, and any positive active material available in the art may be used.

The binder is a component that assists in bonding between the positive electrode active material and the conductive agent and bonding to the current collector, and examples thereof include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, and the like.

The conductive material is not particularly limited as long as it has conductivity without causing a chemical change in the battery. Examples of the conductive material include graphite such as natural graphite and artificial graphite; carbon-based materials such as carbon black, acetylene black, ketjen black, channel black, furnace black, lamp black, and summer black; conductive fibers such as carbon fibers and metal fibers; metal powders such as carbon fluoride, aluminum powder, and nickel powder; conductive whiskeys such as zinc oxide and potassium titanate; conductive metal oxides such as titanium oxide; and conductive materials such as polyphenylene derivatives.

The positive electrode current collector 50 may be an electrically conductive plate-shaped substrate. The positive electrode current collector 50 may include an aluminum foil.

### All-Solid-State Battery Including a Solid Electrolyte

Provided herein is an all-solid-state battery including a solid electrolyte.

The negative electrode current collector 10 may be an electrically conductive plate-shaped substrate. The negative electrode current collector 10 may include at least one selected from the group consisting of nickel (Ni), stainless steel (SUS), and combinations thereof.

The negative electrode current collector 10 may be a high-density metal thin film having a porosity of less than about 1%.

The negative electrode current collector 10 may have a thickness of about 0.1 μm to 10 μm.

The negative electrode layer 20 may include amorphous carbon and a metal alloyable with lithium.

The amorphous carbon may include one or more selected from the group consisting of carbon black, furnace black, acetylene black, ketjen black, and graphene.

The metal may include one or more selected from the group consisting of gold (Au), platinum (Pt), palladium (Pd), silicon (Si), silver (Ag), aluminum (Al), bismuth (Bi), tin (Sn), and zinc (Zn).

FIG. 2 shows a state in which an exemplary all-solid-state battery is charged. When the all-solid-state battery is charged, lithium ions that have moved from the positive electrode layer 40 are precipitated or deposited and stored in the form of a lithium layer 70 between the negative electrode layer 20 and the negative electrode current collector 10. At this time, stress caused by the formation of the lithium layer 70 may act on the negative electrode current collector 10 to deform or break the negative electrode current collector 10. Therefore, the present disclosure is characterized in that breakage of the negative electrode current collector 10 is suppressed by applying the reinforcing layer 60 onto the negative electrode current collector 10. This will be described later.

The solid electrolyte layer 30 is positioned between the positive electrode layer 40 and the negative electrode layer 20 so that lithium ions can move between the two layers.

The solid electrolyte layer 30 may include an oxide-based solid electrolyte or a sulfide-based solid electrolyte. However, it may be preferable to use a sulfide-based solid electrolyte having high lithium ion conductivity. Examples of the sulfide-based solid electrolyte include, but are not particularly limited to, Li₂S—P₂S₅, Li₂S—P₂s₅—LiI, Li₂S—P₂S₅—LiCl, Li₂s—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers, and Z is one of Ge, Zn and Ga), Li₂S—GeS₂, Li₂S—SiS₂—Li₃PO₄, Li₂S—Sis₂—LiₓMO_{y} (wherein x and y are positive numbers, and M is one of P, Si, Ge, B, Al, Ga and In), Li₁₀GeP₂S₁₂, and the like.

The positive electrode layer 40 may include a positive electrode active material, a solid electrolyte, a conductive material, a binder, and the like.

The positive active material may be an oxide active material or a sulfide active material.

Examples of the oxide active material include rock salt bed type active materials such as LiCoO₂, LiMnO₂, LiNiO₂, LiVO₂, and Li₁₊ₓNi_{1/3}Co_{1/3}Mn_{1/3}O₂; spinel type active materials such as LiMn₂O₄, and Li(Ni_{0.5}Mn_{1.5})O₄; inverse spinel type active materials such as LiNiVO₄, and LiCoVO₄; olivine type active materials such as LiFePO₄, LiMnPO₄, LiCoPO₄, and LiNiPO₄; silicon-containing active materials such as Li₂FeSiO₄, and Li₂MnSiO₄; rock salt bed type active materials such as LiNi_{0.8}Co_{(0.2-x)}AlₓO₂ (0<x<0.2) in which a part of the transition metal is substituted with a different metal; spinel type active materials Li₁₊ₓMn_{2-x-y}M_{y}O₄ (wherein M is at least one of Al, Mg, Co, Fe, Ni and Zn, and 0<x+y<2) in which a part of the transition metal is substituted with a different metal; and lithium titanates such as Li₄Ti₅O₁₂.

Examples of the sulfide active material include copper Chevrel, iron sulfide, cobalt sulfide, nickel sulfide, and the like.

The solid electrolyte may be an oxide solid electrolyte or a sulfide solid electrolyte. However, it may be preferable to use a sulfide-based solid electrolyte having high lithium ion conductivity. Examples of the sulfide-based solid electrolyte include, but are not particularly limited to, Li₂S—P₂S₅, Li₂S—P₂s₄—LiI, Li₂s—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers, and Z is one of Ge, Zn and Ga), Li₂S—GeS₂, Li₂S—SiS₂—Li₃PO₄, Li₂S—SiS₂—LiₓMO_{y} (wherein x and y are positive numbers, and M is one of P, Si, Ge, B, Al, Ga and In), Li₁₀GeP₂S₁₂, and the like.

The conductive material may include carbon black, conductive graphite, ethylene black, graphene, or the like.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The positive electrode current collector 50 may be an electrically conductive plate-shaped substrate. The positive electrode current collector 50 may include an aluminum foil.

### Reinforcing Layer

Provided herein is a reinforcing layer 60 is formed on the negative electrode current collector 50 to suppress the breakage of the positive electrode current collector 10 of the lithium ion battery including a liquid electrolyte or all-solid state battery as described herein. However, the reinforcing layer 60 may be applied not only onto the negative electrode current collector 10 but also onto the positive electrode current collector 50. For example, when a plurality of the above-described laminates A are laminated, the reinforcing layer 60 positioned on the positive electrode current collector 50 of any one laminate A may serve to suppress the breakage of the negative electrode current collector 10 of the other laminate A adjacent thereto. Particularly, the reinforcing layer 60 may be positioned on the outside of at least one of the negative electrode current collector 10 and the positive electrode current collector 50.

The reinforcing layer 60 may compensate for low mechanical properties of the negative electrode current collector 10 and/or the positive electrode current collector 50, such as elongation, and relieve and disperse the stress applied to the negative electrode current collector 10 and/or the positive electrode current collector 50, thereby suppressing breakage of the negative electrode current collector 10 and/or the positive electrode current collector 50.

FIG. 3 shows an exemplary reinforcing layer 60. The reinforcing layer 60 may include: a matrix 61 including a polymer; and a thermally conductive filler 62 dispersed in the matrix 61.

The polymer may be obtained by polymerizing one or more selected from the group consisting of amide, chlorobutadiene, butadiene, isoprene, epoxy, vinyl chloride, biphenyl chloride, terephthalic acid, lactic acid, vinyl alcohol, styrene, ethylene, propylene, ester, acrylonitrile, acrylic acid, alginic acid, vinylidene difluoride, cellulose, and bisphenol A.

The thermally conductive filler 62 may impart an appropriate level of mechanical properties to the reinforcing layer 60 and to rapidly discharge heat generated in the laminate A to the outside.

The thermally conductive filler 62 may be in the form of particles. Although FIG. 2 illustrates the thermally conductive filler 62 in a spherical shape, the shape of the thermally conductive filler 62 is not limited thereto, and the thermally conductive filler 62 may have any shape, such as a needle-shape, an oval shape or the like, as long as it can fulfill its role.

The average particle diameter of the thermally conductive filler 62 may be about 50 nm to 500 nm. When the thermally conductive filler 62 has a needle shape, an oval shape, or the like, the particle diameter may mean the longest distance between any one point and other points on the thermally conductive filler 62.

The thermally conductive filler 62 may include an inorganic filler and/or a carbon-based filler.

The inorganic filler may include one or more selected from the group consisting of boron nitride (BN), aluminum nitride (AlN), and silicon carbide (SiC).

The carbon-based filler may include one or more selected from the group consisting of graphite, carbon nanotubes (CNTs), and graphene.

The reinforcing layer 60 may include an amount of about 1 to 400 parts by weight of the thermally conductive filler 62 based on 100 parts by weight of the polymer.

When the content of the thermally conductive filler 62 is less than about 1 part by weight, the effect of heat dissipation may be insignificant, and when the content of the thermally conductive filler 62 is greater than about 400 parts by weight, the processability may be degraded because the content of the polymer is relatively lowered.

The thickness of the reinforcing layer 60 may be about 1% to 100% of the thickness of the negative electrode current collector 10 or positive electrode current collector 50 adjacent to the reinforcing layer 60. For example, the thickness of the reinforcing layer 60 may be about 0.1 μm to 10 μm. When the thickness of the reinforcing layer 60 is within the above range, the breakage of the negative electrode current collector 10 or the positive electrode current collector 50 can be effectively suppressed without problems such as heat dissipation of the laminate A.

The reinforcing layer 60 may further include a conductive material, if necessary. The conductive material may be carbon black, conductive graphite, ethylene black, graphene, or the like.

### Method for Manufacturing Lithium Secondary Battery

Provided is a method for manufacturing a lithium secondary battery that may include steps of: preparing a coating solution containing a polymer and a thermally conductive filler; forming a reinforcing layer 60 by applying the coating solution to at least one surface of a negative electrode current collector 10 and a positive electrode current collector 50; and forming a laminate including: the negative electrode current collector 10; a negative electrode layer 20; an intermediate layer 30; a positive electrode layer 40; the positive electrode current collector 50; and the reinforcing layer 60 positioned on the outside of at least one of the negative electrode current collector 10 and the positive electrode current collector 50.

Each configuration of the lithium secondary battery has been described above, and thus description thereof will be omitted below.

The coating solution may be prepared by adding the polymer to a solvent at a concentration of about 1 wt % to 10 wt % to obtain a polymer solution and adding the thermally conductive filler to the polymer solution in an amount of 1 to 400 parts by weight based on 100 parts by weight of the polymer.

When the order and amount of addition of the components are as described above, the reinforcing layer 60 having good quality may be formed by increasing the dispersibility of each component in the coating solution.

The solvent may be appropriately selected and used depending on the type of polymer. The solvent may suitably include a polar solvent and/or a non-polar solvent. Particularly, the solvent may include one or more selected from the group consisting of hexyl butyrate, xylene, butyl butyrate, N-methyl-2-pyrrolidinone, tetrahydrofuran, acrylonitrile, water, and ethanol.

The method of applying the coating solution is not particularly limited. For example, the reinforcing layer may be formed by applying the coating solution to at least one surface of at least one of the negative electrode current collector and the positive electrode current collector by spin coating, inkjet coating, screen printing, or gravure roll coating.

Thereafter, the laminate A having the laminate structure shown in FIG. 1 may be formed. The method of forming the laminate (A) is not particularly limited. For example, the laminate A may be obtained by attaching the separately prepared negative electrode layer 20, intermediate layer 30, positive electrode layer 40 and positive electrode current collector 50 to the other surface of the negative electrode current collector 10 having the reinforcing layer 60 formed on one surface thereof.

### EXAMPLE

Hereinafter, embodiments of the present disclosure will be described in more detail through examples. The following examples are merely to help understand the present disclosure, and the scope of the present disclosure is not limited thereto.

### Example

Butadiene rubber (BR) as a polymer was added to hexyl butyrate as a solvent at a concentration of about 2 wt % and stirred to obtain a polymer solution. Then, boron nitride (BN) as a thermally conductive filler was added to the polymer solution in an amount of about 25 parts by weight based on 100 parts by weight of the polymer and stirred, thereby preparing a coating solution. The boron nitride used had an average particle diameter of about 200 nm.

A nickel (Ni) thin film having a thickness of about 10 μm was prepared as a negative electrode current collector. The coating solution was applied to one surface of the negative electrode current collector by gravure roll coating and dried to form a reinforcing layer having a thickness of about 0.7 μm.

A slurry containing the amorphous carbon SuperC65, the metal silver (Ag) alloyable with lithium, and the binder polyvinylidene fluoride (PVDF) was prepared, applied to the other surface of the negative electrode current collector, and dried to form a negative electrode layer having a thickness of about 8 μm.

A solid electrolyte layer, a positive electrode layer, and a positive electrode current collector were sequentially laminated on the negative electrode layer, thereby manufacturing an all-solid-state battery.

### Comparative Example

An all-solid-state battery was manufactured in the same manner as in the Example, except that the reinforcing layer was not formed.

### Experimental Example

Each of the all-solid-state batteries according to the Example and the Comparative Example was charged and discharged twice at 0.1 C, and then charged and discharged at 0.5 C until the number of charging and discharging reached 25, thereby one cycle of charging and discharging. Thereafter, the above cycle was repeated.

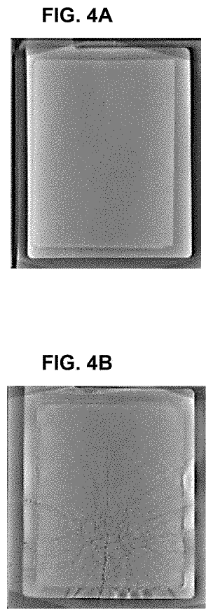

FIG. 4A shows a computed tomography (CT) image of the all-solid-state battery according to the Example after the all-solid-state battery was charged and discharged 100 times. FIG. 4B shows a computed tomography (CT) image of the all-solid-state battery according to the Comparative Example after the all-solid-state battery was charged and discharged 100 times.

As shown in FIGS. 4A and 4B, the all-solid-state battery of the Example was in very good condition, whereas breakage occurred in the all-solid-state battery of the Comparative Example.

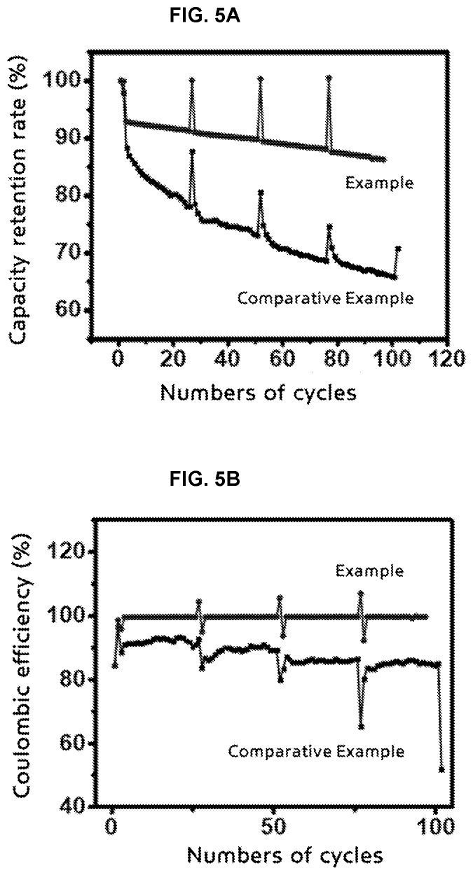

FIG. 5A shows the results of measuring the capacity retention rates of the all-solid-state batteries according to the Example and the Comparative Example. FIG. 5B shows the results of measuring the coulombic efficiencies of the all-solid-state batteries according to the Example and the Comparative Example. As shown in FIGS. 5A and 5B, the all-solid-state battery of the Example showed a capacity retention rate of 85% or more and a coulombic efficiency close to 100% even after it was charged and discharged 100 times, whereas the all-solid-state battery of the Comparative Example showed rapid degradation in the capacity retention ratio and the coulombic efficiency.

According to various exemplary embodiments of the present disclosure, the current collector may be effectively prevented from being broken by volume expansion of the electrode, and thus it is possible to obtain a lithium secondary battery having excellent cell performance and cycle life characteristics.

The effects of the present disclosure are not limited to the above-mentioned effects. It should be understood that the effects of the present disclosure include all effects that can be deduced from the above description.

While the embodiments of the present disclosure have been described in detail, the scope of the present disclosure is not limited to the above-described embodiments, and various modifications and improvements made by those skilled in the art using the basic concept of the present disclosure as defined in the appended claims are also included in the scope of the present disclosure.

What is claimed is:

1. A lithium secondary battery comprising:
a negative electrode current collector;
a negative electrode layer disposed on the negative electrode current collector;
an intermediate layer disposed on the negative electrode layer and comprising a solid electrolyte or a separator;
a positive electrode layer disposed on the intermediate layer;
a positive electrode current collector disposed on the positive electrode layer; and
a reinforcing layer disposed on an outside of at least one of the negative electrode current collector and the positive electrode current collector and comprising a matrix comprising a polymer and a thermally conductive filler dispersed in the matrix.

2. The lithium secondary battery of claim 1 wherein the negative electrode layer comprises a negative electrode active material or lithium metal.

3. The lithium secondary battery of claim 1, wherein the negative electrode layer comprises amorphous carbon and a metal comprising one or more selected from the group consisting of gold (Au), platinum (Pt), palladium (Pd), silicon (Si), silver (Ag), aluminum (Al), bismuth (Bi), tin (Sn), and zinc (Zn).

4. The lithium secondary battery of claim 1, wherein the polymer comprises a copolymer comprising one or more selected from the group consisting of amide, chlorobutadiene, butadiene, isoprene, epoxy, vinyl chloride, biphenyl chloride, terephthalic acid, lactic acid, vinyl alcohol, styrene, ethylene, propylene, ester, acrylonitrile, acrylic acid, alginic acid, vinylidene difluoride, cellulose, and bisphenol A

5. The lithium secondary battery of claim 1, wherein the thermally conductive filler is in the form of particles, and has an average particle diameter of about 50 nm to 500 nm.

6. The lithium secondary battery of claim 1, wherein the thermally conductive filler comprises one or more selected from the group consisting of boron nitride (BN), aluminum nitride (AlN), and silicon carbide (SiC).

7. The lithium secondary battery of claim 1, wherein the thermally conductive filler comprises one or more selected from the group consisting of graphite, carbon nanotubes (CMTs), and graphene.

8. The lithium secondary battery of claim 1, wherein the reinforcing layer comprises the thermally conductive filler in an amount of about 1 to 400 parts by weight of based on 100 parts by weight of the polymer.

9. The lithium secondary battery of claim 1, wherein a thickness of the reinforcing layer is about 1% to 100% of a thickness of a current collector adjacent to the reinforcing layer.

10. The lithium secondary battery of claim 1, wherein the reinforcing layer has a thickness of about 0.1 μm to 10 μm.

11. A method for manufacturing a lithium secondary battery comprising steps of:
preparing a coating solution comprising a polymer and a thermally conductive filler;
forming a reinforcing layer by applying the coating solution to at least one surface of a negative electrode current collector and a positive electrode current collector; and
forming a laminate comprising: a negative electrode current collector; a negative electrode layer disposed on the negative electrode current collector; an intermediate layer disposed on the negative electrode layer and comprising a solid electrolyte or a separator; a positive electrode layer disposed on the intermediate layer; a positive electrode current collector disposed on the positive electrode layer; and a reinforcing layer disposed on the outside of at least one of the negative electrode current collector and the positive electrode current collector.

12. The method of claim 11, wherein the coating solution is prepared by adding the polymer to a solvent at a concentration of about 1 wt % to 10 wt % to obtain a polymer solution and adding the thermally conductive filler to the polymer solution in an amount of about 1 to 400 parts by weight based on 100 parts by weight of the polymer.

13. The method of claim 11, wherein the polymer is obtained by polymerizing one or more selected from the group consisting of amide, chlorobutadiene, butadiene, isoprene, epoxy, vinyl chloride, biphenyl chloride, terephthalic acid, lactic acid, vinyl alcohol, styrene, ethylene, propylene, ester, acrylonitrile, acrylic acid, alginic acid, vinylidene difluoride, cellulose, and bisphenol A.

14. The method of claim 11, wherein the thermally conductive filler is in the form of particles and has an average particle diameter of about 50 nm to 500 nm.

15. The method of claim 11, wherein the thermally conductive filler comprises one or more selected from the group of:
one or more inorganic fillers selected from the group consisting of boron nitride (BN), aluminum nitride (AlN), silicon carbide (SiC), and combinations thereof; and
one or more carbon-based fillers selected from the group consisting of graphite, carbon nanotubes (CNTs), graphene, and combinations thereof.

16. The method of claim 12, wherein the solvent comprises one or more selected from the group consisting of hexyl butyrate, xylene, butyl butyrate, N-methyl-2-pyrrolidinone, tetrahydrofuran, acrylonitrile, water, and ethanol.

17. The method of claim 11, wherein the reinforcing layer is formed by applying the coating solution to at least one surface of at least one of the negative electrode current collector and the positive electrode current collector by spin coating, inkjet coating, screen printing, or gravure roll coating.

18. The method of claim 11, wherein a thickness of the reinforcing layer is about 1% to 100% of a thickness of a current collector adjacent to the reinforcing layer.

19. The method of claim 11, wherein the reinforcing layer has a thickness of about 0.1 μm to 10 μm.

20. The method of claim 11, wherein the negative electrode layer comprises:
a negative electrode active material;
lithium metal; or
amorphous carbon and a lithium-alloyable metal comprising one or more selected from the group consisting of gold (Au), platinum (Pt), palladium (Pd), silicon (Si), silver (Ag), aluminum (Al), bismuth (Bi), tin (Sn), and zinc (Zn).
